(19) United States
(12) Patent Application Publication
(10) Pub. No.: US 2009/0117941 A1
(43) Pub. Date: May 7, 2009

(54) Structure of radio front end and antenna for mobile base station

(76) Inventor: Qun Li, Milpitas, CA (US)

Correspondence Address: Qun Li, 891 Spirit Walk, Milpitas, CA, 95035, US

(21) Appl. No.: 12/290,472

(22) Filed: Oct. 31, 2008

(30) Foreign Application Priority Data
Nov. 5, 2007 (CN) 2007101985227

(51) Int. Cl. H04M 1/00

(52) U.S. Cl. 455/562.1

(57) ABSTRACT

A combination structure of radio front end and antenna for wireless base station and a means of share the antenna for multiple carriers are presented. The front part of the antenna has several independent radiation units for spatial combining radiation of multiple carriers. There is a heat dissipation cavity with natural air flow in back part of the antenna. The radio front end circuits formed a module with heat sink panel are installed in the cavity and on the back panel of the antenna.

### FIELD OF THE INVENTION

The present invention relates to a structure design of radio front end and antenna for mobile base station, and a means of share the antenna for multiple carriers.

### BACKGROUND OF THE INVENTION

The radio front end of the traditional mobile base station (BS) required power amplifier (PA) with big RF power output. The power consumption of the BS is quite large because: 1. Very low power efficiency of the PA itself but large output power is required. The power efficiency of the PA itself is less than 50% for GSM and about 25% for CDMA and OFDM even using last technology with big cost, complexity and low reliability. For example, 100 W PA release 100 W or 300 W heat; 2. There is large insertion loss by coax cable between antenna and RF front end of the BS. For example, 80% of antenna tower in North America is 30˜50 m high. The cable with two jumpers and several connectors including inside connectors in cabinet of the BS has total 5˜7 dB insertion loss that means 70˜80% RF power became heat; 3. To multiple carriers GSM base station, each carrier needs to be amplified by one itself PA and then be combined to one channel by several combiners. The combined signal is transferred to antenna from BS by a costly, thick, heavy, low loss cable. For example by four carriers GSM BS, combining of the carriers transfer 80% the RF power to heat which is increasing as the number of the carrier is increasing; 4. The fan, exchanger even air conditioner inside of BS are required to dissipate the heat. Especially strong cooling air flow is required for PA because mass heat is concentrated in tiny area, which is much more difficult to dissipate compare with normal electrical circuits. 30% extra heat is distributed typically by fan system and power supply system. 70% of power consumption of BS is come from requirement of PA. Only 2.5% less of the energy consumed by PA become effective radiation power in the antenna port. The 97.5% of the electrical power is transformed to harmful heat inside of the BS which creates very low efficiency and very low reliability as a whole of the BS. The failure rate of the PA module because the high temperature and the failure rate of the fan are highest compared with failure rate of other parts of the BS. The cost, weight, size, power consumption, noise and maintenance frequency of BS are increased dramatically. It is much harder and harder to install the BS in the rooftop of the resident building. The fee for installation place is increasing very fast even higher than BS equipment cost in some area.

The auto-tuned cavity combiner can reduce the insertion loss but can not solve the all problems synthetically and go with high cost. The remote radio unit (RRU) could reduce the cable insertion loss but ten thousands of components per sector are placed in cabinet with high temperature PA on tower top, as result of which the feasibility to install the RRU on tower top, reliability, maintain ability and cost to clamber tower are all became serious problems. The operators in the Occident would rather put the RRU on the ground than the tower top to avoid excessive failure time and upkeep.

The purposes of the invention are: 1. Avoid the cable loss to upgrade the PA efficiency of normal wireless BS while reduce the complexity of the equipment installation on tower top and ensure the high reliability and easy maintenance; 2. The PA are separated from BS cabinet to reduce 70% heat of the main cabinet. The system of the heat dissipation can be simplified, the power of the power supply can be reduced, the size and weight of the BS cabinet can be much smaller, and the system reliability will be much higher; 3. The PA with much less power as tenth than normal is used. The natural heat dissipation by fully utilizing of previous mechanical structure of the antenna is adopted to avoid use of low reliable turning parts like fan and heavy heat sink. The total weight of the equipment is reduced and the reliability of the tower equipment is increased; 4. The combiner is not used or less used for multiple carriers GSM BS to farther increase the efficiency of the GSM BS; 5. The coax cable with large diameter which is heavy, costly, hard to install and easy to fail is avoided; 6. The radiation power and the electrical down tilt of the sub-antenna for different carrier with specified zone are set differently according the distance of the specified zone and traffic, by which the less power is consumed by BS, less co-channel interference of wireless net is created so that the data rate can be higher and communication quality is better. On all accounts, 70% of the power consumption of the whole system is saved; the communication reliability is increased; the weight, size, heat, noise, CAPEX, failure rate, failure time and OPEX of the mobile BS will be reduced dramatically.

The most techniques of the invention can be used for any standard of wireless communication BS.

### SUMMARY OF THE INVENTION

It is a primary object of the present invention to provide a structure design of the radio front end and antenna for BS to reduce the cost, heat and failure rate. The special designs are 1. The radio front end parts are moved out from BS. Several special designed RF modules composed of much smaller power PA or LNA or some other structures, are installed in back panel of the antenna with hot swap function; 2. The back mechanical structure of the antenna is modified to a special cavity for natural heat dissipation of the RF modules; 3. Adopt directional antenna with dual rows and dual polarizations to combine carriers in space instead of traditional combiner; the two rows of vertical array have different electrical down tilt; 4. Adopt a cable bundle with several thin cables instead of traditional very thick cable. According this project, each carrier is amplified itself by one small PA. The small PA is installed in back panel of antenna on tower top instead of in tank of BS on ground. The power requirement of PA has inverse ratio with number of carriers. Take example by four carriers BS, 7 dB loss is for combine of four carriers, 5 dB is for cable loss so that four of small PA with one fifteenth power of the traditional PA can be used, which are easily to installed to back panel of antenna from the view of weight, size, heat and reliability.

The antenna adopted in this project has dual rows and dual polarizations which are isolated each other to form four independent sub-antennas. The each polarization of the each row produces one radio beam with 65 degree or 90 degree of beam width. Total four independent beams are created and corresponded to the four independent sub-antennas.

When one or two carriers are used, the output ports of one or two PA are connected to one or two feed ports of the dual polarization of one row of the antenna. The input ports of the one or two PA are connected to relative ports of the cable bundle. The two ports of the dual polarization of another row of the antenna are connected to two input ports of the two LNA to make diversity receiving.

When the number of the carriers is more than two, the RF front end module (RFE) composed of one PA, one LNA and two duplexers with two ports is required. The RFE has one port to share one sub-antenna for both transmitter and receiver and another port to share one thin cable for signal transfer between RFE and BS. For example, one RFE instead of one LNA is required for share one antenna for both PA and LNA in another row of the antenna when three carriers are used. For same reason, two RFE are used to instead of the two LNA when the BS is working in four carriers.

Each RF module is waterproofed and installed independently in back panel. A cool waiting structure designed for redundancy of each PA module is doable because the very low cost of the small PA.

One traditional directional antenna with dual polarization came with one or two RFE modules are doable if the number of the carriers is less than three in future plan. Otherwise, the directional antenna with dual rows and dual polarizations is the better choice.

Because the cost is much lower, the more power amplifiers, more cables than requirement can be preinstalled in the back panel of the antenna to create RFE channel redundancy which can add the system reliability, reduce the maintenance requirement on tower top and the failure time of the wireless net dramatically.

If five to eight carriers are used, the PA module or RFE module with dual PA is required. Two PA are replaced one PA with a combiner to form a PA with dual-PA module or RFE with dual-PA module. The dual-PA module now has two ports in cable end but still has one port in antenna end. The cable bundle could be preset up to eight thin cables inside for possible future carrier upgrade. Under the structure of this project, carrier upgrade of the radio front end from one to eight or even more is simple by increase or change of PA module, RFE module or dual-PA module depending on the number of the carriers. These RF modules are installed in back panel of the antenna individually and very easy to exchange by hot swap on tower top without any disturbing to the communication.

The tuning and retuning of the output power for each carrier is easy and flexible because all of the PA modules are installed separately and independently and also easy to change. The radiation powers for different carriers with specified zone can be set differently according the distance of the specified zone and traffic. The larger power is set to the carrier to respond the terminals from far zone for which the sub-antenna with smaller electrical downtilt is used. The smaller power is set to the carrier to respond the terminals from near zone and the sub-antenna with larger electrical downtilt is adopted. One large power and one small power are separately adopted by two opposite sectors with same reused frequency but being separated by other cells. The arrangement of the different power and different antenna downtilt can reduce the power consumption, co-channel interference and radio pollution to increase communication capacity and quality. The output power can be remote tuned by set up different DC bias of the PA.

The radiation unit in front part of the antenna is independent and waterproofed. The air tunnel is formed by the back cavity of the antenna with opened up side and down side. The cooling air flow from bottom to top is created naturally when the PA modules installed inside of the cavity are working. The air tunnel is rainproof.

The PA module or RFE module is combined with heat sink panel to form the PA-Heat sink module or RFE-Heat sink module (simplify to RF-Heat sink module). Some heat pipe could be installed in the heat sink panel if the PA is quite large or the average temperature of the local weather is very high.

Several installation windows are preset in the back panel of the antenna. The RF-Heat sink modules are installed in these windows by screws or other mechanical method. The connections between the RF module and antenna could be two or three short RF cables or RF penal jack by hot swap to simplify the module exchange.

There are two or three RF sockets in the back face of the ground panel of the radiator corresponding to each back panel window. One socket is inside connected to the radiator feeding port of one independent antenna above mentioned. Other one or two sockets are inside connected to the antenna feeding socket fixed in back panel of the antenna. The front panel of RF module has two or three RF plugs in correspond locations of the RF sockets above mentioned. One plug is inside connected to PA output. Other one or two plugs are inside connected to PA input or dual-PA inputs. These connectors are waterproofed.

The electrical connecting, VSWR testing and mechanical fixing between these RF-Heat sink modules, antenna and maybe the cable bundle are all finished in manufactory to ensure the high reliability of the connections. The redundant carrier PA, RFE channels have been preset therefore the changing of the RF module on tower top is only happened when the extra carrier upgrade is required or more than one or two modules are failed which has a little chance. The module exchange is very simple and easy without any variation of antenna stance and performance. Hot swap is feasible without any impact to the communication state.

### BRIEF DESCRIPTION OF THE DRAWINGS

Preferred embodiments of the invention are described herein below with reference to the drawing wherein:

FIG. 1 is a block diagram of a traditional structure of PA and antenna for four carriers BS;

FIG. 2 is a block diagram of an inventional structure of PA and antenna for four carriers BS;

FIG. 3 is a block diagram of a PA redundant module including a cool waiting PA;

FIG. 4 is a block diagram of a working mode of RFE and antenna for one or two carriers BS;

FIG. 5 is a block diagram of a RFE module structure;

FIG. 6 is a block diagram of a working mode of RFE and antenna for three or four carriers BS;

FIG. 7 is a block diagram of a dual-PA module;

FIG. 8 is a block diagram of a working mode of RFE and antenna for five or six carriers BS;

FIG. 9 is a side view of an invention antenna;

FIG. 10a is a top view of the invention antenna;

FIG. 10b is a top view of the inventional antenna with an extra heat sink panel;

FIG. 11 is a side view of an electrical connection configuration between RF module and antenna;

FIG. 12 is a front view of a back panel of the inventional antenna with installation windows;

FIG. 13 is a front view of the back panel with windows and RF/Heat sink modules installed on the windows;

FIG. 14 is a side view of a RF module with a heat sink panel installed on the back panel of the antenna;

FIG. 15 is a front view of the RF module with the heat sink panel which has heat pipes in it;

FIG. 16 is a top view of the RF/heat sink module installed on the back panel of the antenna;

FIG. 17 is a side view of a RF module with a heat sink panel and a window panel installed on the back panel of the antenna;

FIG. 18 is a front view of the RF module with the heat sink panel installed heat pipes on it, and the window panel;

FIG. 19 is a top view of the RF/heat sink/window panel module installed on the back panel of the antenna;

FIG. 20 is a side view of a RF module with a heat sink panel, some metal rails and a window panel installed on the back panel of the antenna;

FIG. 21 is a front view of the RF module with the heat sink, the metal rails and the window panel;

FIG. 22 is a top view of the RF/heat sink/rail/window panel module installed on the back panel of the antenna;

FIG. 23 is shown that each sub-antenna of the base station is set to different radiation down tilt and power for different carrier.

### DESCRIPTION OF THE PREFERRED EMBODIMENT

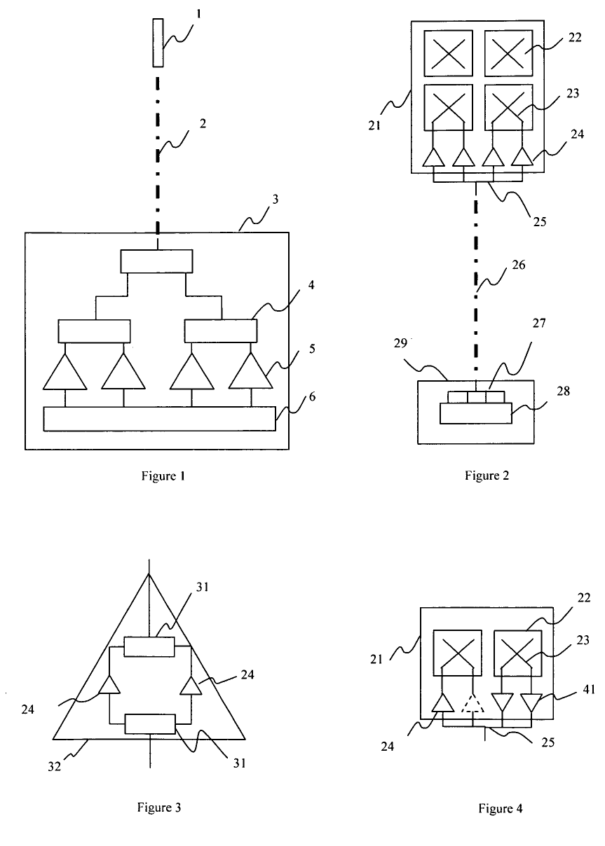

In the traditional structure of the four carriers GSM BS illustrated on the block diagram of FIG. 1, transmitter 6 supplies four driving carriers to the four of high-power PA 5 separately and the four powered carriers are combined to one channel by three combiners in the BS cabinet 3 on the ground. The combined four carriers are transferred to the directional antenna 1 by the thick coax cable 2.

FIG. 2 illustrates the improved structure by this invention in which there is no any large PA 5 in the BS cabinet 29 on the ground. Through connector 27, four cables of cable bundle 26 and connector 25, the transmitter 28 in BS cabinet 29 supply four driving carriers to four of small-power PA 24 installed on back panel of the antenna 21. The antenna 21 is composed of front part and back part. The front part is the radiator made of two independent vertical arrays 22 in which each element is made of two cross polarized generator 23. The four independent sub-antennas are formed by the four vertical series of generator 23. The four feed ports of the sub-antennas are connected to the four outputs of the PA 24. The four PA are installed in the back part of the antenna. The two independent vertical arrays 22 can be arranged by horizontal or by vertical. More than two of the vertical arrays maybe are required which could be arranged by both horizontal and vertical.

With a cool waiting PA part, the Redundant PA module 32 illustrated in FIG. 3 has higher reliability which is composed of two switches 31 and two PA 24. The Redundant PA 32 is a good choice because the low PA cost and high reliability. The redundant structure is suitable to other types of RF module mentioned later.

The RFE/Antenna structure 21 illustrated in FIG. 4 is working as mode of one or two carriers. The two groups of cross polarized generators 23 in the left vertical array 22 and one or two PA 24 are formed one or two carrier transition units. The two groups of cross polarized generator 23 in the right vertical array 22 and two LNA 41 are formed two diversity receiving units. They are connected to transceiver 28 in BS 29 through connector 25.

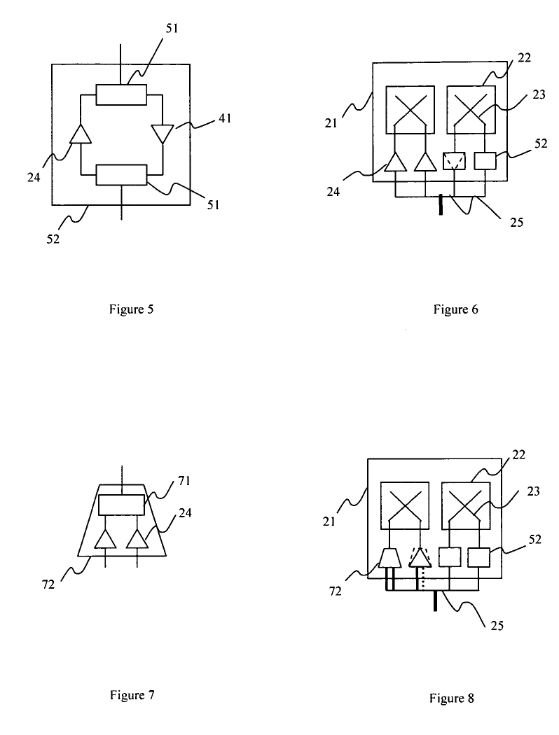

A RFE module 52 made of one PA 24 or 32, one LNA 41 and two duplexers 51 is used for share one sub-antenna 23 by both transmitting and receiving when the number of carrier is more than two, which is illustrated in FIG. 5.

One LNA 41 illustrated in FIG. 4 is replaced by one RFE 52 to share one sub-antenna 23 for both transmitting and receiving when the system is working in mode of three carriers. Two LNA 41 are replaced by two RFE 52 to share two sub-antennas 23 for two carriers as illustrated in FIG. 6.

A Dual-PA module 72 is illustrated in FIG. 7 which is composed of two PA 24 and one combiner 71 to use for share one generator 23 by two carriers. The module has two input ports and one output port. By same logic, a Dual-PA/RFE module has similar structure.

When five carriers are adopted, two RFE module 52 are used on the right array of the antenna to amplify two carriers and two receiving signals through the two sub-antennas. On the other hand to the left array, one module is PA 24 to amplify one carrier, another is dual-PA 72 to amplify two carriers but through only one sub-antenna, so that five carriers are amplified as illustrated in FIG. 8. Six carriers can be amplified if the two modules of the left side are both dual-PA.

Anyhow seven, eight even more carriers can be handled by same logic.

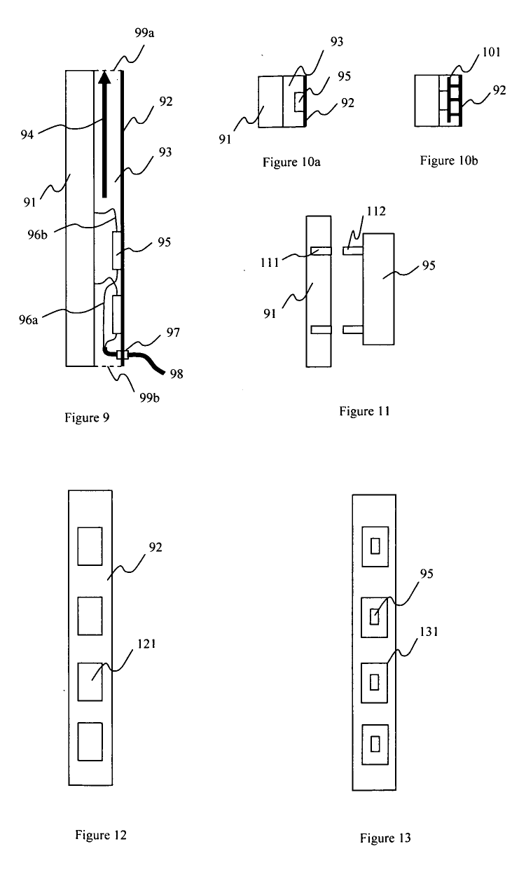

Side view of the antenna 21 is illustrated in FIG. 9 with front part and back part. The front part in left side of the antenna is radiator 91 in which the electrical structure is illustrated in FIG. 2. The back part of the right side of the antenna 21 is composed by ground panel of radiator 91, back panel 92 of the antenna 21 and cavity 93 by the enclosure structure 91, 92, 99A, 99B and side wall. The cavity is closed surrounding but opened for up side and down side to form an air tunnel 93 in which air flow from bottom to top is created when the PA modules are working. The top side and bottom side are blocked by two screens 99A, 99B. The modules 24, 32, 41, 52, 72 mentioned above are defined as RF module 95 in FIG. 9 and installed in separate places of the cavity for easy to heat dissipation. A RF socket 97 is installed on the back panel 92, which is connected to one feed port of RF module 95 by cable 96a and connected to feed port of BS 29 by cable bundle 98. Another port of the RF module is connected to one feed port of one sub-radiator 91 through cable 96b.

The RF module 95 is installed on back panel 92 which is illustrated in top view of FIG. 10a. The back panel 92 acts as heat sink of PA also.

The other top view of FIG. 10b shows different structure in which RF module 95 is not installed in back panel 92 directly but in a special heat sink panel 101 which is fixed in back panel 92. The back panel acts both heat sink and havelock.

FIG. 11 shows an electrical connection between RF module and sub-antenna. 112 are two RF plugs on RF module. 111 are two RF sockets on ground panel of radiator 91, by which one sub-antenna 23 and one sub-connector of the RF socket 97 on the back panel are connected inside of the antenna.

The front view of back panel 92 is illustrated in FIG. 12. There are four windows 121 on the panel for installation of RF module 95 and its heat sink panel. The size and arrangement of the windows 121 on the panel 92 are different depended the shape of the antenna and the heat amount of the PA. For example, one vertical series of the windows arranged from top to bottom of the panel can be used in slightness antenna.

The four windows 121 of the back panel 92 with installed RF module 95 and its heat sink panel 131 are showed in FIG. 13.

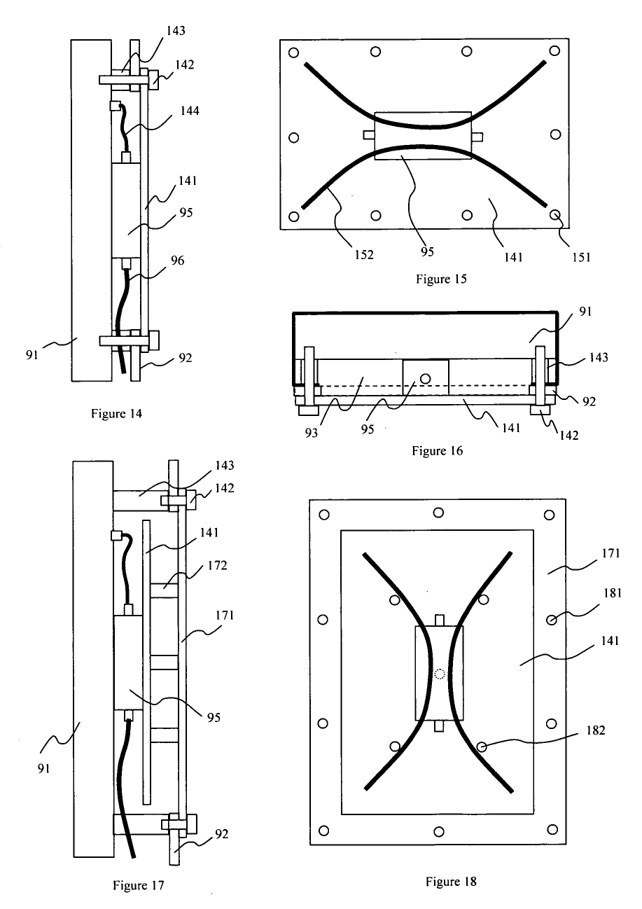

Side view and top view of the installation of a RF module 95 in a window 121 of the antenna 21 shown in FIG. 14 and FIG. 16 is showed that a RF module 95 and its heat sink/window panel 141 are fixed on antenna back panel 92 and ground panel of the radiator 91 through fix bolts 142, back-up washers 143. The materiel of the all parts is metal with good thermal conductivity. The thermal resistance of the interfaces between the parts is designed as small as possible. The connection between module 95 and radiator 91 could be short cables 96 or one pair of RF jack and socket by which a direct hot swap of RF module is used for changing of the RF module 95. The connections of cables 96 are described in FIG. 9.

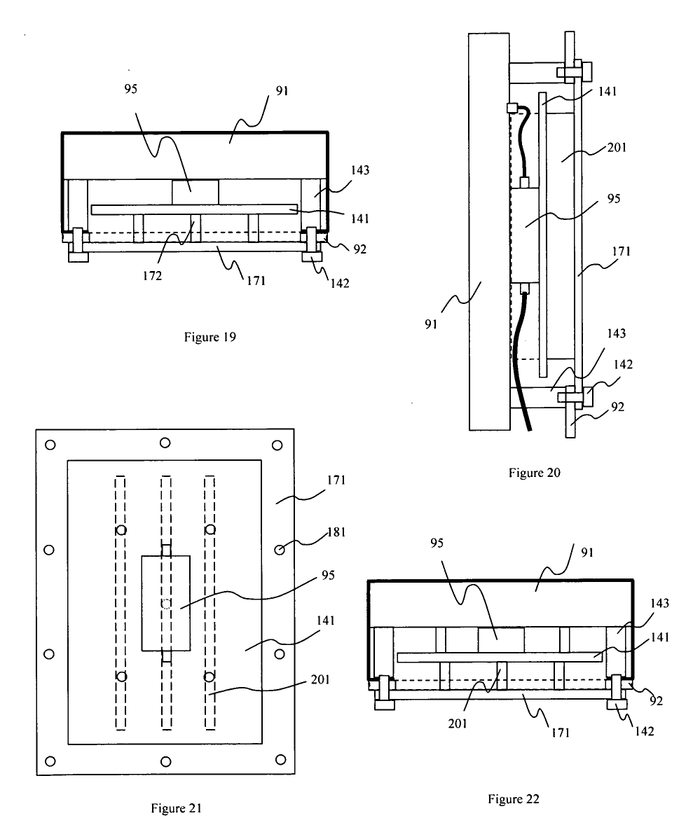

The RF/heat sink module made of RF module 95 and window/heat sink panel 141 is shown in FIG. 15 by front view. Part 152 are heat pipes which could be installed in panel 141 depended on heat situation. Screw holes 151 are used to fix the panel 141 to window 121 of the panel 92. Other configuration of RF/heat sink module and its installation is illustrated in FIG. 17, FIG. 18 and FIG. 19. The difference compared with structure shown in FIG. 14 is that the heat sink 141 is not fixed to the back panel 92 directly but to a special window panel 171 through some back-up washers or metal supporters 172. The window panel 171 is fixed to the back panel 92 by screw 142, supporter 143 and acts as second heat sink and havelock. The configuration has larger area to heat dissipation and less sun heat but more weight.

FIG. 20, FIG. 21 and FIG. 22 illustrate one modified configuration compared with above design, in which the supporters 172 are replaced by several metal rails 201 which acts as heat sink, thermal conductor and supporter. The new structure has smaller thermal resistance.

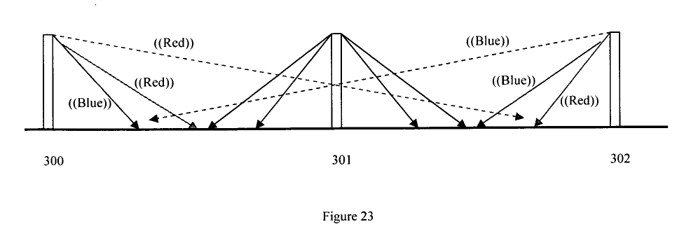

FIG. 23 illustrate that each sub-antenna 21 above mentioned of each base station (300, 301, 302) is set to different radiation down tilt and power for different carrier separately. Base station 300 reuses the same frequency pair with the base station 302 correspondingly which is separated with base station 300 by other base station 301. The real red line and the real blue line represent the two different carriers. The dot line of red or blue represents the co-channel interference of each carrier in opposite sector correspondingly. The base station 300 uses red line carrier with smaller down tilt and larger power to handle the mobile stations in far zone of the sector but uses blue line carrier with larger down tilt and smaller power to process the mobile stations in near zone of the same sector. Contrariwise, the base station 302 uses blue line carrier with smaller down tilt and larger power for the far zone and uses red line carrier with larger down tilt and smaller power for the near zone. Obviously by using the new antenna structure and frequency plan the smaller co-channel interference and radiation pollution of the wireless network can be achieved by which the data transportation rate and network capacity should be increased.

What are claimed are:

1. A structure of an antenna comprising:
a) There are two independent parts of the antenna including front part and back part. The front part is the radiator of the antenna including two or more independent vertical arrays which could be arranged by horizontal, vertical or both. Each element of the each vertical array is made of two cross polarized generator. The four or more independent sub-antennas with the four or more feed ports are formed by the four or more vertical series of the generators which have preset different radiation down tilt or a function to tune the radiation down tilt independently;
b) The back of the antenna is a cavity which is closed surrounding by back panel, ground panel of the radiator and sidewall but opened to up and down sides to form an air tunnel. The RFE parts of BS such as PA, LNA, and duplexer are installed on the back panel and inside of the tunnel which acts as container and heat sink. An air flow from bottom to top is created by the heat of the working PA inside of the cavity to dissipate the heat;
c) One RFE module composed of one PA with quite small output power compared with a traditional design, one LNA and two duplexers is used to share one sub-antenna and one coax cable connected to BS for transmition and receiving;
d) The adopting of the antenna as mentioned in claim 1, a), two small PA modules and two RFE modules can be used to transmit four carriers and receive two diversity signals. Four RFE modules could be used to increase the receiving redundancy;
e) The transmition of one channel between the transceiver of the BS and the RF module of the antenna is completed by one coax cable which can be very thin compared with the requirement of the traditional design. The several thin cables are combined to one cable bundle. Therefore only one cable bundle is required between the antenna and the base station. One socket for the cable bundle is installed in the back panel of the antenna;
f) The connection between the one feed port of the RF module and the feed port of the one sub-antenna and the other connection between the other feed port of the RF module and the one feed port of the socket of the cable bundle could be one pair of short cable or two pair of RF plug and socket by which plug-in RF module is used. The plug-in mode can make the change of the RF module simple and reliable. The hot swap is used to avoid any interrupt of the communication under this structure;

2. The structure of the antenna of claim 1 comprising:
a) A dual-PA module composed by two small PA and one combiner with two input ports and one output port is used to amplify two carriers and share one sub-antenna, two thin cables connected to base station. The single PA modules are instead of dual-PA modules when the number of carrier is five or six. In same logic, one or two dual-PA/RFE modules are used when the number of carrier is seven or eight;
b) The coax cable bundle as mentioned in 1, e) could be preset to have four, eight or more thin cables depending the future upgrade requirement;

3. The PA module, RFE module and dual-PA module according to claim 1 and claim 2, could be further comprising a cool waiting PA with two switches for redundancy to form redundant RF module;

4. The structure of the antenna of claim 1 comprising extra PA modules and thin cables then requirement are preinstalled in the back panel of the antenna for redundancy of the radio front end;

5. The structure of the antenna of claim 1 comprising:
a) There are several windows on the back panel of the antenna to used for installation of the RF modules of claim 1 to 3 and its heat sink parts which are constructed to RF/Heat sink module;
b) Each RF/Heat sink module is fixed on a corresponding window of the back panel by metal bolt or other mechanical method.

6. The structure of the RF/Heat sink module of claim 4 comprising:
a) The heat pipe can be installed on the heat sink panel to boost up the ability of heat dissipation;
b) The interface thermal resistance between the RF module and the ground panel of the radiator, between the surrounding edge of the heat sink panel and surrounding edge of the widow of the back panel is designed as small as possible. The thermal conductive glue or other material can be used between the contacted surfaces.

7. The other structure of the RF/Heat sink module of claim 4 comprising a extra window panel on which the RF/Heat sink module is installed by several metal, thermal conductive support poles. The window penal with the RF/Heat sink module is fixed to the window of the back panel of the antenna. The interface thermal resistance between the mechanical parts is designed as small as possible. The window panel acts as havelock and second heat sink panel.

8. The other structure of the RF/Heat sink module of claim 6 comprising several metal, thermal conductive rails instead of the support poles, which fix the RF/Heat sink panel to the window panel and tightly contact to the ground panel of the radiator. The interface thermal resistance between the all mechanical parts is designed as small as possible. The rails act as thermal conductor, heat sink and supporters;

9. The all electrical connections, testing and mechanical fixing between the RF/Heat sink modules, antenna and cables above mentioned are finished in manufactory to insure the good quality;

10. The structure of the antenna of claim 1 comprising:
a) The antenna gain, radiation down tilt and radiation power are preset different for each of the four or more sub-antennas according the distance of the specified zone and traffic. The smaller down tilt, larger gain and power are set to the sub-antenna to respond the mobile stations from the far zone. The larger down tilt, smaller gain and power are set to the sub-antenna to process the terminals from the near zone;
b) Sub-antenna with small down tilt and large power in one base station is in the opposite position with the another sub-antenna with large down tilt and small power in another base station both which reuse same frequency but being separated by other base station;
c) The different power setting could be set by using different PA module or by different DC biasing for same PA module which can be remote controlled by software.

1. A structure of an antenna comprising:
a) There are two independent parts of the antenna including front part and back part. The front part is the radiator of the antenna including two or more independent vertical arrays which could be arranged by horizontal, vertical or both. Each element of the each vertical array is made of two cross polarized generator. The four or more independent sub-antennas with the four or more feed ports are formed by the four or more vertical series of the generators which have preset different radiation down tilt or a function to tune the radiation down tilt independently;
b) The back of the antenna is a cavity which is closed surrounding by back panel, ground panel of the radiator and sidewall but opened to up and down sides to form an air tunnel. The RFE parts of BS such as PA, LNA, and duplexer are installed on the back panel and inside of the tunnel which acts as container and heat sink. An air flow from bottom to top is created by the heat of the working PA inside of the cavity to dissipate the heat;
c) One RFE module composed of one PA with quite small output power compared with a traditional design, one LNA and two duplexers is used to share one sub-antenna and one coax cable connected to BS for transmition and receiving;
d) The adopting of the antenna as mentioned in claim 1, a), two small PA modules and two RFE modules can be used to transmit four carriers and receive two diversity signals. Four RFE modules could be used to increase the receiving redundancy;
e) The transmition of one channel between the transceiver of the BS and the RF module of the antenna is completed by one coax cable which can be very thin compared with the requirement of the traditional design. The several thin cables are combined to one cable bundle. Therefore only one cable bundle is required between the antenna and the base station. One socket for the cable bundle is installed in the back panel of the antenna;
f) The connection between the one feed port of the RF module and the feed port of the one sub-antenna and the other connection between the other feed port of the RF module and the one feed port of the socket of the cable bundle could be one pair of short cable or two pair of RF plug and socket by which plug-in RF module is used. The plug-in mode can make the change of the RF module simple and reliable. The hot swap is used to avoid any interrupt of the communication under this structure;

2. The structure of the antenna of claim 1 comprising:
a) A dual-PA module composed by two small PA and one combiner with two input ports and one output port is used to amplify two carriers and share one sub-antenna, two thin cables connected to base station. The single PA modules are instead of dual-PA modules when the number of carrier is five or six. In same logic, one or two dual-PA/RFE modules are used when the number of carrier is seven or eight; b) The coax cable bundle as mentioned in 1, e) could be preset to have four, eight or more thin cables depending the future upgrade requirement;

3. The PA module, RFE module and dual-PA module according to claim 1 and claim 2, could be further comprising a cool waiting PA with two switches for redundancy to form redundant RF module;

4. The structure of the antenna of claim 1 comprising extra PA modules and thin cables then requirement are preinstalled in the back panel of the antenna for redundancy of the radio front end;

5. The structure of the antenna of claim 1 comprising:
a) There are several windows on the back panel of the antenna to used for installation of the RF modules of claim 1 to 3 and its heat sink parts which are constructed to RF/Heat sink module;
b) Each RF/Heat sink module is fixed on a corresponding window of the back panel by metal bolt or other mechanical method.

6. The structure of the RF/Heat sink module of claim 4 comprising:
a) The heat pipe can be installed on the heat sink panel to boost up the ability of heat dissipation;
b) The interface thermal resistance between the RF module and the ground panel of the radiator, between the surrounding edge of the heat sink panel and surrounding edge of the widow of the back panel is designed as small as possible. The thermal conductive glue or other material can be used between the contacted surfaces.

7. The other structure of the RF/Heat sink module of claim 4 comprising a extra window panel on which the RF/Heat sink module is installed by several metal, thermal conductive support poles. The window penal with the RF/Heat sink module is fixed to the window of the back panel of the antenna. The interface thermal resistance between the mechanical parts is designed as small as possible. The window panel acts as havelock and second heat sink panel.

8. The other structure of the RF/Heat sink module of claim 6 comprising several metal, thermal conductive rails instead of the support poles, which fix the RF/Heat sink panel to the window panel and tightly contact to the ground panel of the radiator. The interface thermal resistance between the all mechanical parts is designed as small as possible. The rails act as thermal conductor, heat sink and supporters;

9. The all electrical connections, testing and mechanical fixing between the RF/Heat sink modules, antenna and cables above mentioned are finished in manufactory to insure the good quality;

10. The structure of the antenna of claim 1 comprising:
a) The antenna gain, radiation down tilt and radiation power are preset different for each of the four or more sub-antennas according the distance of the specified zone and traffic. The smaller down tilt, larger gain and power are set to the sub-antenna to respond the mobile stations from the far zone. The larger down tilt, smaller gain and power are set to the sub-antenna to process the terminals from the near zone;
b) Sub-antenna with small down tilt and large power in one base station is in the opposite position with the another sub-antenna with large down tilt and small power in another base station both which reuse same frequency but being separated by other base station;
c) The different power setting could be set by using different PA module or by different DC biasing for same PA module which can be remote controlled by software.
